(19) United States
(12) Patent Application Publication
(10) Pub. No.: US 2003/0046450 A1
(43) Pub. Date: Mar. 6, 2003

(54) Dynamic data-centered programming

(76) Inventors: Ravi Narayanan, Plano, TX (US); Richard Patchet, Allen, TX (US); Peter Brockmann, Allen, TX (US)

Correspondence Address: Ortiz & Lopez, PLLC, P.O. Box 7720, Dallas, TX, 75209, US

(21) Appl. No.: 10/163,659

(22) Filed: Jun. 5, 2002

Related U.S. Application Data
(60) Provisional application No. 60/317,027, filed on Sep. 4, 2001.

(51) Int. Cl. G06F 15/163; G06F 9/00; G06F 9/54

(52) U.S. Cl. 709/331

(57) ABSTRACT

A method and system for enabling dynamic data-centered programming in a distributed computer network, such as, for example, the Internet or Intranet-based computer networks. A software method can be dynamically associated with an instance of incoming data utilizing at least one processing node within the distributed computer network. The software method can be dynamically located utilizing a discovery mechanism integrated with the distributed computer network. The software method can also be dynamically fetched from any location with the distributed computer network, wherein at least one processing node can dynamically program itself for a current instance of incoming data, such that all future instances of an identical type of incoming data can also be processed utilizing the software method without searching the distributed computer network and downloading the software method.

### CROSS REFERENCE TO RELATED PATENT APPLICATION

This patent application is related to a provisional patent application entitled, “Process Router Method and System,” Serial No. 60/317,027, which was filed on Sep. 4, 2001. This patent application claims priority to the Sep. 4, 2001 filing date of the above referenced provisional patent application.

### TECHNICAL FIELD

The present invention is related to distributed computer networks, such as, for example, the Internet and Intranet-based networks. The present invention is also related to data routers and methods and systems thereof. The present invention is also related to methods and systems for exchanging data among nodes contained within distributed computer networks. The present invention is also related to business-to-business, application-to-application and enterprise application integration methods and systems. The present invention is additionally related to electronic business trading networks and methods and systems thereof. The present invention is also related to computer programming languages utilized in distributed computer networks and distributed computing systems.

### BACKGROUND OF THE INVENTION

Packet-based communication networks (such as the Internet) transfer information between computers and other equipment using a data transmission format known as packetized data. The stream of data from a data source (e.g., a host computer) can be divided into variable or fixed length “chunks” of data (i.e., packets). Switches (e.g. routers) in the network route the packets from the data source to the appropriate data destination. In many cases, the packets can be relayed through several routers before they reach their destination. Once the packets reach their destination, they can be reassembled to regenerate the stream of data.

Conventional packet-based networks generally utilize a variety of protocols to control data transfer throughout a network. For example, the Internet Protocol (“IP”) defines procedures for routing data through a network. To this end, IP specifies that the data is organized into frames, each of which includes an IP header and associated data. The routers in the network use the information in the IP header to forward the packet through the network. In the IP vernacular, each router-to-router link can be referred to as a “hop”.

The Transmission Control Protocol (“TCP”) defines additional functions, such as, for example, data flow control and reliable data transfer. TCP specifies that the data is organized into segments, each of which includes a TCP header and associated data. TCP specifies that a destination must acknowledge segments that it successfully receives. Thus, after the destination receives a segment that has not been corrupted in transit and all previous packets were received, the destination sends an acknowledgment message to the source. In simplified terms, if the source does not receive an acknowledgment within a predefined period of time, the source retransmits the segment. (There are additional situations in which TCP will initiate a retransmission. Inasmuch as these situation are well known in the art, they will not be discussed in detail here.)

Conventional routers can route packets only when another device (such as an application generating the data) selects the destination end device and identifies the destination by setting the relevant fields in the packet header. Routing techniques utilized in conventional routers were developed at a time when processing capacity available in the routers and transmission capacity available between routers (i.e., I/O capacity or network bandwidth) were limited. To cope with such limitations, header formats were standardized to simplify router software and save processing capacity in routers; such routing software was stored inside the routers to save the transmission capacity available between routers. Today, processing power and transmission capacity are abundant.

In prior art information technology (IT) environments, data was typically configured proprietary to a given application. For example, customer information stored in an order management application is usually not available to another application, such as an accounting software module. However, there is a growing need for applications to use information from each other for an integrated view of corporate resources. To address this growing need, corporations modify their applications to send and receive data from each other for integrated processing.

Inter-business communications over networks, such as the Internet, for example has become common as enterprises share information with each other in real-time and make decisions that benefit the entire community of business partners. Networks that enable inter-business communications (e.g., “trading networks”), however, are complicated by a multitude of partners, each with their own business document formats and their own notion of routing logic and business processes.

In typical business settings, multi-level approval processes are required for certain decisions such as approval for business related travel, raising capital for expansion through bank-loans and hiring personnel. In these examples, an approval document is sent to those who need to approve a transaction in some predetermined order. In such cases, the document is accompanied by a routing slip which specifies the order in which the document needs to be routed to the approving persons and the conditions based on which it is routed further down the chain or returned (rejected at any stage).

The Internet and other communication networks generally provide avenues for communication among people and computer platforms. Such computer platforms can be utilized for a wide variety of transactions, including commercial transactions in which participants buy and sell goods and services. Many efforts are underway to facilitate commercial transactions on the Internet. However, with many competing standards, in order to execute a transaction, the parties to the transaction must agree in advance on the protocols to be utilized, and often require custom integration of the platform architectures to support such transactions. Commercial processes internal to a node not compatible with agreed upon standards can require substantial rework for integration with other nodes. Furthermore, as a company commits to one standard or the other, the company becomes locked-in to a given standardized group of transacting parties to the exclusion of others.

In recent years, mark-up languages have become prevalent. Two examples of mark-up languages are Hyper-Text Markup Language (HTML) and extensible Markup Language (XML), both derivatives of Standard Generalized Markup Language (SGML). Of the well-known mark-up languages, XML is becoming universally accepted as a standard way to code data structures for data to be exchanged among applications. XML's popularity can be attributed to its ability to contain self-describing data; as shown in FIG. 3, XML documents contain not only the data (shown at the bottom of the XML document in figure) but also rules (shown at the top of the XML document in figure) that define the organization of the XML data and the constraints of the values that XML data elements can comprise. The current XML technology allows applications that exchange XML documents to ensure that the document is formed correctly. However, the interpretation of the XML documents and their data elements for the purpose of computation, decisions, routing and storage are typically found in proprietary software, which is resident inside application software that is separate from the XML document. That is, XML provides no standard way for two applications in communication to interpret and apply the same business logic to a given XML document.

A need thus exists for methods and systems, which would permit services to be transformed dynamically and automatically from one format to another without excessive or any user intervention. A need also exists for methods and systems for enhancing routing services, such as name resolution, destination selection, route selection, and physical routing over distributed networks such as the Internet and/or associated Intranets. Additionally, a need exists for methods and systems for enhanced automation services including inter-business processes and procedure. A need also exists for automatic and dynamic negotiation services for businesses, including so-called “dynamic handshakes,” relationship establishments, security (i.e., authentication, authorization, privacy, etc.) over a computer network. Furthermore, such negotiations services, including routing services, transformation services, and automation services should preferably be highly scalable and flexible.

Distributed computing systems, such as, for example, distributed computer networks, have a need to exchange data among the various nodes (“processing nodes”) of the system and to process the data cooperatively. The data processing capabilities of a processing node in a distributed system can be computational, decisional, and/or capable of routing or execution of protocols in conjunction with the other nodes of the system. Software methods are typically required for implementing such data processing in the processing nodes of distributed systems. Traditionally, software methods required to process all the known types of data that can be received by a processing node of the distributed system are programmed into processing nodes. In addition, where processing nodes accessed software methods from each other to complete the data processing, they rely on prior knowledge (at processing node creation time—development, compilation or configuration) of the types of software methods required to complete a specific process.

Such a distributed system where processing nodes have prior knowledge of the capabilities of each other is a tightly coupled system. Tightly coupled systems that contain pre-determined software methods among the processing nodes work adequately in a controlled environment where the number of data types can be limited and constrained and where the different software developers and administrators work in a team. It can thus be appreciated that in a large, loosely connected, highly distributed network environment (for example: the Internet), any mechanism relying on the ability to control the data types or relies on the knowledge of all software methods is not adequate. A more flexible mechanism to derive software methods in such distributed computing environments is thus required.

### BRIEF SUMMARY OF THE INVENTION

The following summary of the invention is provided to facilitate an understanding of some of the innovative features unique to the present invention, and is not intended to be a full description. A full appreciation of the various aspects of the invention can be gained by taking the entire specification, claims, drawings, and abstract as a whole.

It is an aspect of the present invention to provide methods and systems for implementing self-contained modules of data and associated processing information (i.e., “software methods”) as an object.

It is another aspect of the present invention to provide methods and systems for enabling dynamic data-centered programming in distributed computer networks.

It is yet another aspect of the present invention to provide dynamic data-oriented software binding techniques.

It is still another aspect of the present invention to provide dynamic software locating techniques.

The above and other aspects of the present invention can be achieved as is now described. Methods and systems are disclosed for enabling dynamic data-centered programming in a distributed computer network, such as, for example, the Internet or Intranet-based computer networks. A software method can be dynamically associated with an instance of incoming data utilizing at least one processing node within the distributed computer network. The software method can be dynamically located utilizing a discovery mechanism integrated with distributed computer networks. The software method can also be dynamically fetched from any location within a distributed computer network, wherein at least one processing node can dynamically program itself for a current instance of incoming data, such that all future instances of similar types of incoming data can also be processed utilizing the current software method without searching the distributed computer network and downloading the software method.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 illustrates a block diagram comparing a conventional server approach to a distributed computing approach, which can be implemented in accordance with a preferred embodiment of the present invention;

FIG. 2 depicts a block diagram illustrating dynamic software derivation scenarios, in accordance with a preferred embodiment of the present invention;

FIG. 3 illustrates a block diagram illustrating a configuration of incoming data options, in accordance with a preferred embodiment of the present invention; and

FIG. 4 depicts a block diagram illustrating cascaded software downloading, in accordance with a preferred embodiment of the present invention.

### DETAILED DESCRIPTION OF THE INVENTION

The particular values and configurations discussed in these non-limiting examples can be varied and are cited merely to illustrate embodiments of the present invention and are not intended to limit the scope of the invention.

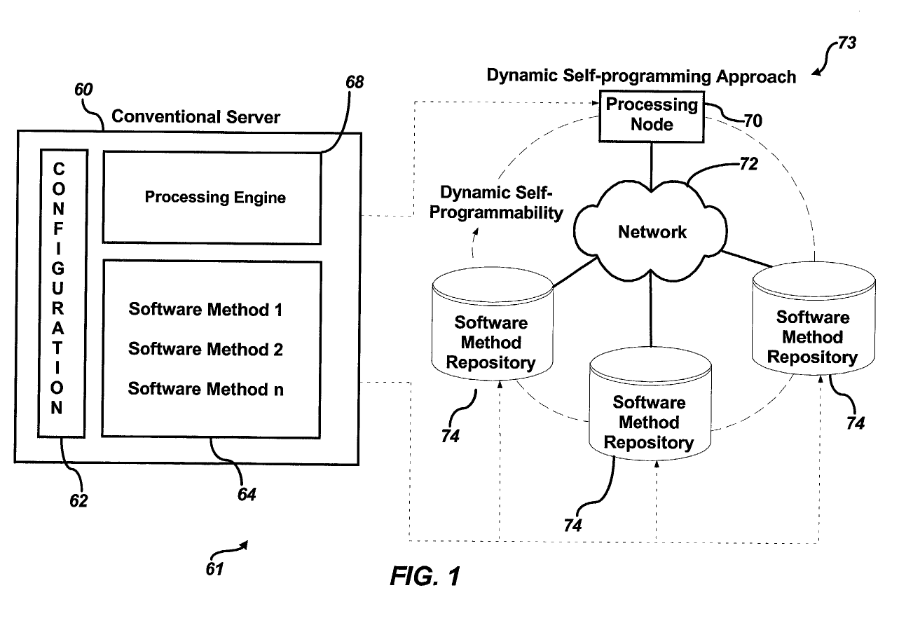

FIG. 1 illustrates a block diagram 61 comparing a conventional server approach 60 to a distributed dynamic self-programming approach 73, which can be implemented in accordance with a preferred embodiment of the present invention. In conventional server approach 60, a tightly coupled computing model is illustrated, in which software methods and services 64 are bundled with a processing engine 68 and wrapped with a set of configuration options 62 tightly together in a server system (i.e., conventional server approach 60). There are significant disadvantages with such an approach. First, services or features required for engagement are built into the product based on product vendors' limited understanding of market requirements and their product development resource constraints. Secondly, the features requiring a specific instance of the implementation are selected and configured at the installation time. Therefore, such a conventional approach is rendered incapable of addressing dynamic situations that occur in networks. This approach severely limits the number of variations that can be addressed by products constructed using conventional server approach 60.

A superior approach is thus indicated by distributed dynamic self-programming approach 73 of the present invention, which creates a flexible, distributed platform and lets the industry, including end-customers, system integrators, independent software vendors and other vendors access the product platform to add capabilities as they see fit and enable the linking of capabilities to the processing node in real-time. Thus, as illustrated in FIG. 1, a processing node 70 is generally linked to the network 70, which can include distributed software method services 74.

Distributed computing approach 73 is thus a distributed dynamically linked approach, unlike conventional server approach 60, which represents the prior art. Utilizing conventional server approach 60, services or features required at a customer's implementation are selected at installation time and configured into the server. This prior art approach severely limits the server's ability to adapt to the dynamic nature of Internet environments where partners often join and then quickly depart and wherein partners unbeknownst to the implementation at installation time introduce new formats and processes.

The distributed computing approach 73 of the present invention, permits the system to dynamically program itself based on a given situation. Such an approach can be implemented by selecting the services to be performed based on the object being processed and the environment (i.e., name spaces, specific partner preferences or constraints, time of day or month).

As indicated previously, distributed computing systems have a need to exchange data among the various nodes (“processing nodes”) of the distributed system or distributed network and to process the data cooperatively. The data processing capabilities of a processing node in a distributed system (e.g., Internet, Intranet, etc.) can be computational, decisional, and/or capable of routing or executing protocols in conjunction with the other nodes of the distributed system. Software methods are typically required for implementing such cooperative data processing in the processing nodes of a distributed system.

Traditionally, software methods required to process all known types of data that can be received by a processing node of the distributed system are generally programmed into processing nodes. In addition, if processing nodes accessed software methods from each other to complete the data processing, they generally rely on prior knowledge (i.e., at processing node creation time—development, compilation or configuration) of the types of software methods required to complete a specific process. Such a distributed system where processing nodes have prior knowledge of the capabilities of each other is a tightly coupled system.

Tightly coupled systems that contain pre-determined software methods among the processing nodes are adequate in a controlled environment where the number of data types is limited, can be constrained and where the different software developers and operators work in a team. In a large, loosely connected, highly distributed network environment (for example: the Internet), these assumptions are not valid, so it is inadequate to rely on control of the data types or prior knowledge of each software method. A more flexible mechanism to derive software methods in such distributed computing environments is required.

In accordance with preferred or alternative embodiments of the present invention, new approaches for discovering software methods in a loosely connected, highly dynamic, highly distributed network environment are disclosed herein. An approach disclosed as a preferred embodiment of the present invention is founded on three basic principles:

1. Dynamic data-centered software binding: the processing nodes' ability to dynamically determine and associate the appropriate software method with a given instance of incoming data or a part of incoming data.

2. Dynamic software locating: the processing nodes' ability to dynamically discover and locate the software method using flexible, ordered, network-wide discovery techniques.

3. Dynamic Self-programming: the processing nodes' ability to dynamically fetch the appropriate software method from anywhere in the network, and dynamically program itself for the current instance of incoming data such that all future instances of the same type of incoming data can also be processed using this software method without the need to search the network and download the software.

The present invention thus discloses various aspects of an architecture, which can enable dynamic software programmability in a distributed data processing environment, such as, for example, the Internet or Intranet-based computer networks, through a discussion herein of the following topics: timing related to binding of software methods to the objects requiring processing; software method derivation scenarios; software method naming procedures; the location of the software methods; and the search order employed to discover software methods.

The term “timing,” as utilized herein, specifies when to obtain a software method. Software methods can be obtained by processing nodes dynamically under several conditions: upon receipt of incoming data; when the current software method does not know how to deal with a condition in the data; when one software method requires another software method(s) to complete its own processing; and when one software method has completed its operations and must transfer control to another software method for further processing.

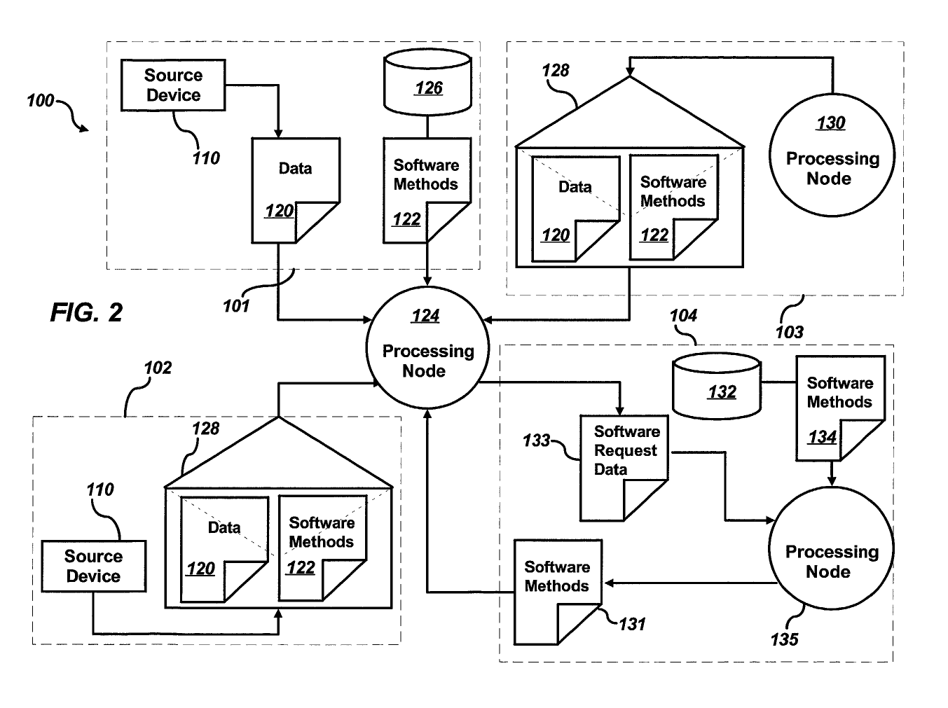

FIG. 2 depicts block diagram 100 illustrating dynamic software derivation scenarios, in accordance with a preferred embodiment of the present invention. In the configuration illustrated in block 100, scenarios 101, 102, 103, and 104 are illustrated. As indicated by scenario 101, a processing node 124 can dynamically download software methods 122 corresponding to the received data (i.e., data 120) from an external data source (i.e., source device 110). Software methods 122 can be downloaded from a database 126. As depicted by scenarios 102 and 103, processing node 124 can receive data 120 and software methods 122 intended to process data from an upstream device, either another processing node (i.e., processing node 130) or a source device, such as, for example, an application or database system. Data 120 and software methods 122 can be bundled together in a package 128. Note that in FIG. 2, like parts are indicated by like reference numerals, but are illustrated under varying scenarios and conditions. Finally, as indicated by scenario 104, processing node 124 can request (i.e., via software request data 133) and receive software methods 131 from another processing node 135. Processing node 135 can received software methods 134 from database 132.

A name allows selection of an appropriate software method from a collection of software methods. In order to obtain a software method to process the incoming data from a collection of software methods available to the processing node, developer(s) of the software methods can use a set of naming conventions and the processing node can be programmed to use the same naming conventions to locate a software method from a vast collection of software methods. Many naming choices can be implemented, in accordance with preferred and/or alternative embodiments of the present invention.

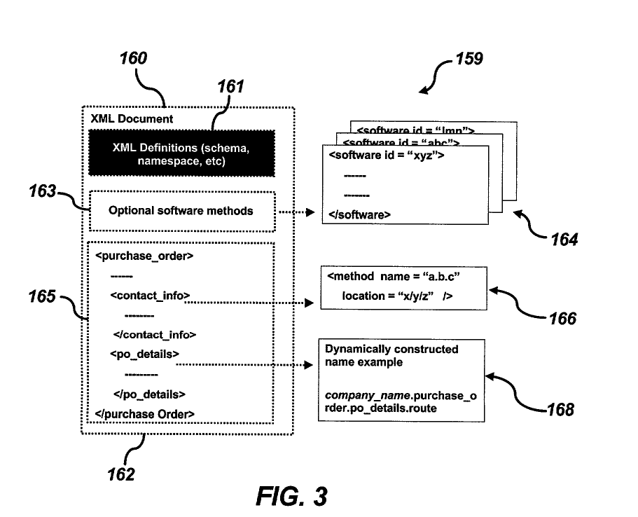

The name of the software method chosen or desired can be derived from a predetermined position of the incoming data. The name of a desired software method can also be derived from the value of a predetermined element of the incoming data. FIG. 3 illustrates a block diagram 159 illustrating a configuration of incoming data options, in accordance with a preferred embodiment of the present invention. As indicated in FIG. 3, an XML document 160 is illustrated. Note that extensible Markup Language—XML—is presented herein for illustrative purposes only and is not considered a limiting feature of the present invention. Thus, the methods and systems of the present invention can apply to non-XML documents as well as XML data. In FIG. 3, XML document 160 includes XML definitions 161, software methods 163 (which can be optional) and information 165 that includes purchase order, contact details and other business-to-business information, which can be dynamically constructed, as indicated at block 168. Block 166 illustrates how a naming convention can be implemented, in accordance with the present invention. Block 164 indicates specific types of software methods that can be optionally associated with XML document 160. The name of the method utilized to process incoming “contact_info,” as illustrated in FIG. 3, can thus be specified as an attribute of a specific element called “method.”

The “name” of the software method can also be derived utilizing the value of a predetermined element of the incoming data as a key (or index) into a list of names that correspond to the collection of software methods. Additionally, the name of the software method can be derived utilizing the value of a predetermined element of the incoming data as a pointer to a location containing the name, and optionally the content, of the required software method. Concatenating one or more of the following and not necessarily in the following order can also form the name of the software method:

a. The identity of the processing node.

b. The role of the processing node (if multiple types of processing nodes are used in a distributed computing system where each type of processing node performs a role).

c. The value(s) of one or more elements of the incoming data; note that this option allows one processing node to send the name of the software method to another processing node.

d. The name(s) of one or more elements of the incoming data.

e. The function that must be performed by the software method.

Some examples of the functions performed by the software method include calculation (e.g., computation of extended price from the information present in the incoming data, etc.); formatting of the data (e.g., add, delete, split, combine, modify data); decisional (i.e., what to do with the data and/or what functions must be invoked to complete the data processing); data routing (i.e., selection of the destination and the route as well as forwarding); and protocol execution (e.g., business process, workflow, networking protocol).

As illustrated in FIG. 3, the name of the method to be used to route the purchase_order can be constructed by concatenating processing node id (company_name corresponding to the enterprise that is processing the purchase_order); the element name of the overall data (purchase_order); element_name of the data that is required to determine the routing logic (po_details); and the function that needs to be performed (route).

As utilized herein, “location” specifies the places where the software method can be found. Software methods specified by the name (see “naming”) can be placed in a variety of locations.. The software method can be located in a predetermined position of the incoming data. As illustrated in FIG. 3, the software method can be located at the beginning (i.e., see reference numeral 163) of XML document 160 (predetermined position). The software method can also be located as the value of a predetermined element of the incoming data. Note that this option allows one processing node to send the location of the software method to another processing node. As indicated in FIG. 3, the software method can be located as the value of the element called “software” (i.e., see block 164). The software method can also be located within the memory of the processing node or within an attached storage device dedicated to the processing node. In addition, the software method can be located within a remote storage device dedicated to the processing node or within an attached storage device shared by the processing node with other devices. The software method can also be located within a remote storage device shared by the processing node and other devices. Finally, the software method can simply be located at another processing node either in its own memory or in a storage device accessible to the other processing node.

The actual location (i.e., utilizing one of the choices above) of the software method for a given instance of data can be specified through a variety of manners. For example, the location of the software method can be specified in a predetermined position of the incoming data. The location of the software method can be also specified as the value of a predetermined element of the incoming data. Additionally, the value of a predetermined element of the incoming data can be utilized as a key (or index) into a list of names that correspond to the location of software methods. The value of a predetermined element of the incoming data can also be utilized as a pointer to a location containing the location of the required software method.

Previously as described herein, various physical places from which software methods can be obtained by the processing node were specified. Four techniques by which the processing node can determine which of the eight locations actually contain the software methods were described above. In case the location is not specified through any of the above-described methods, the locations described above can be searched utilizing the method in a predetermined order. The search order can be obtained using any of the following techniques:

1. The search order can be programmed or configured into the processing node.

2. The search order can be embedded in the incoming data either in a predetermined position of the data or as a value of a predetermined element in the data (note that this option allows one processing node to send the search order to another processing node).

3. The search order can be available in an external storage medium, where the location and the path to the search order can be specified in a predetermined position of the data or in a predetermined element in the data (note that this option allows one processing node to send the location and path of the search order to another processing node).

If a search order includes another processing node, and the processing node is not specified explicitly, the processing node that sent the incoming data and/or the processing node that is to receive data from the current processing node can be searched.

The present invention thus discloses several novel approaches for dynamically discovering software methods in a loosely connected, highly dynamic, highly distributed network environment. The present invention enables processing nodes in a networked environment to dynamically locate and download software methods and program themselves to process data resident in the processing node. By comparison, conventional software systems require data to be sent to the software method and get them processed. The novel approach disclosed in this invention has the same performance characteristics as the conventional method for the first instance of the data to be processed. However, for every subsequent instance of the data, the novel approach is considerably superior in terms of performance.

The present invention also enables software methods to be coded specific to parts of data to be processed. For example, as illustrated in FIG. 3, software methods required for processing po_details within the purchase_order (i.e., see reference numeral 165) can be developed and located by a software developer or administrator independent of another software developer or administrator who is coding and locating software methods for processing “contact_info” for future escalation.

Prior art data processing systems, including prior art distributed computing systems and networks, generally require the name or an alias of the name of the software method (remote or local) to be specified in the processing node at the time of development, compilation or configuration. Since the binding of the name used by the processing node and the name of the software method is static, the current techniques require that the developer or administrator of the processing node and the developer or administrator of the software methods must coordinate and synchronize the names of the software methods. The present invention disclosed herein permits a processing node to construct the name of the software methods based on the content of the incoming data and a variety of real-time conditions, using a naming convention. This novel method allows the processing node to dynamically discover the required software methods that are also named using the same naming convention. This dynamic binding capability allows the processing nodes to access software methods that were developed and administered independent of the processing node.

The various location and search mechanisms disclosed in this invention enables processing nodes to fetch software methods from virtually anywhere in the network. Cascading through multiple processing nodes using this invention to fetch software methods enables distributed computing systems to be implemented with little concern about where to store or locate software methods. Note that this invention does not preclude the use of caching for efficient storage and retrieval of software methods obtained by utilizing the techniques described herein.

In distributed systems, including distributed computer networks, involving multiple business partners, it is possible to define software methods used by all of the business partners and store them in a shared repository. Utilizing the dynamic software loading approach described herein, a processing node (i.e., proxy for a business partner) can download a shared software method, apply some company-specific logic to the shared software, and store the customized software method locally. The flexible search options allow this processing node to fetch the custom software method from its local storage while the other processing nodes in the network can continue to use the common software methods in the shared repository. This novel feature of the present invention allows one business entity to use a modified version of the method without affecting the shared parent software methods that are used by the other business partners.

In distributed systems involving multiple business partners, each business entity is capable of specifying the business logic for the services that they provide for their partners who need the service. Therefore, it is efficient for each business entity to implement methods that abstract their services and allow other partners to share the methods. The present invention described herein, thus can enable cascaded software derivation in such applications.

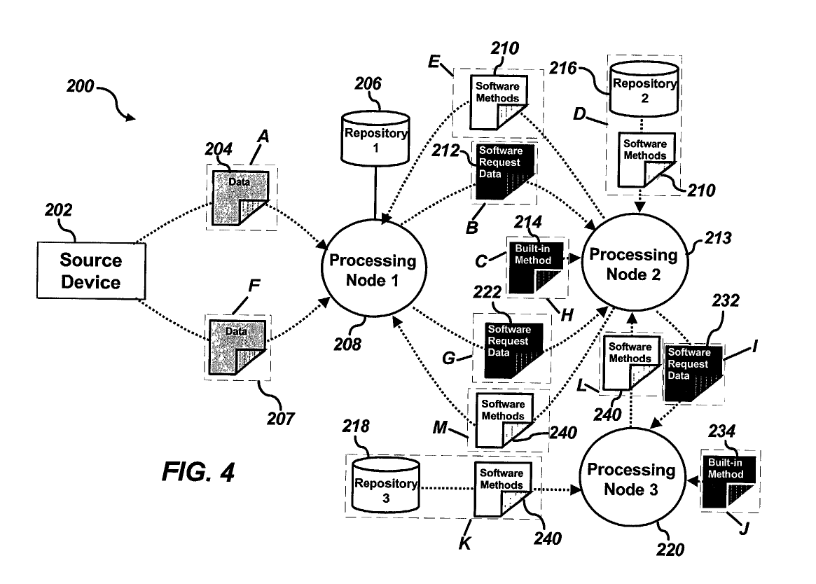

FIG. 4 depicts block diagram 200 illustrating cascaded software downloading, in accordance with a preferred embodiment of the present invention. As indicated in FIG. 4, arrival of data 204 into a processing node 208 that belongs to a business entity can trigger request for and obtain software methods 210 (e.g., business logic) to process data 204 from processing nodes that belong to the business partners. As indicated at block A, data 204 can be retrieved by processing node 208 (i.e., processing node 1) from source device 202. Note that block A is indicated in FIG. 4 by dashed lines. Dashed lines also indicate other blocks illustrated in FIG. 4. Thus, source device 202 can send data to processing node 208, as illustrated at position A in FIG. 4.

Processing node 208 can search its own repository 206 (i.e., repository 1) based on a search order and determine that repository 206 does not contain the software methods necessary to process incoming data 204. Note that repository 206, 216 and 218 can be configured as an internal memory location or an attached storage device. As indicated at block B, processing node 208 can thus send a special request to processing node 213 (i.e., processing node 2), which is next in its search order, with the name of the software method embedded in the request (i.e., software request data 212).

As described at block C, processing node 213 can process the incoming data (i.e., software request data 212) using a built-in software method 214 that is generally present in all processing nodes to process the special software request data (i.e., software request data 212). Thereafter, as indicated at block D, the built-in software method 214 in processing node 213 can search repository 216 (i.e., repository 2), which contains the required software method. Then, as described at block E, processing node 213 can send software methods 210 to processing node 208.

Another scenario is also illustrated in FIG. 4, indicated how one processing node can obtain software methods from another processing node by cascading through an intermediate processing node. Thus, as illustrated at block F, a source device can send data 207 to processing node 208. Processing node 208 will then search its own repository 206 based on the search order and determine that repository 206 does not contain software methods necessary to process the incoming data 207. Therefore, processing node 208 sends a special request to processing node 213 (i.e., next in its search order) with the name of the software method embedded in the request (i.e. software request data 222), which is illustrated at block G. Processing node 213 processes the incoming data (i.e., software request data 222), as illustrated at block G, utilizing a built-in software method (i.e., built-in software method 214) that is present in all processing nodes to process the special software request data 222, as indicated at block H. Note that block H and C generally represents the same operational step, only in varying scenarios.

As depicted next at block I, the built-in software method 214 present in processing node 213 searches repository 216 based on the search order and finds that it does not contain the software methods necessary to process the incoming data 207. Therefore, processing node 213 sends another special request 232 to processing node 220 (i.e., processing node 3), which is next in its search order, with the name of the required software method embedded in the request (i.e., software request data 232). Thereafter, as illustrated at block J, processing node 220 processes the incoming data (i.e., software request data 232) utilizing a built-in software method 234 that is present in all processing nodes to process the special software request data 232. As indicated next at block K, the built-in software method 234 in processing node 220 search repository 218 (i.e., repository 3), which contains the required software method (i.e., software method 240). Then, as indicated at block L, processing node 220 can send software method 240 to processing node 213. As illustrated at block M, processing node 213 can send software method 240 to processing node 208. Note that as utilized herein the terms “software method” and “software methods” can be utilized interchangeably and can refer to a singular software method or to a plurality of software methods. Also note that in FIG. 4, like parts are indicated by identical reference numerals.

Based on the foregoing it can thus be appreciated that the present invention disclosed herein can enable software method physically distributed across a computer network or computer system to be available as a logical library of software methods that can be shared by multiple processing nodes, either tightly coupled or loosely connected. The present invention also enables software methods and services offered by one business entity, such as, for example, an enterprise or service provider, to be accessed by other business entities. This is particularly useful in software distribution as well as inter-business trading over distributed computer networks.

It can be appreciated by those skilled in the art that the methods and systems described herein can be implemented as a program product (e.g., a control program residing in computer memory) containing instructions that when executed on a CPU, can carry out the operations and features illustrated in FIGS. 1 to 4 herein. While the present invention is described in the context of a fully functional computer system, those skilled in the art can further appreciate that the present invention is capable of being distributed as a program product in a variety of forms, and that the present invention applies equally, regardless of the type of signal-bearing media utilized to actually carry out the distribution. Examples of signal-bearing media include recordable-type media, such as floppy disks, hard-disk drives and recordable CD ROM's and transmission type media, such as digital and analog communication links. Preferred implementations of the invention can include implementations to execute the methods and systems described herein as a program product residing in a memory of a microcomputer, a dynamic routing device, such as a dynamic router or, for example, a memory location of one or more servers within a distributed computer networks, such as, for example, the Internet or one or more Intranet-based computer networks.

The program product thus can include sets of instructions for executing the methods and systems of the present invention described herein. Until required by a microcomputer, the set of instructions can be stored as a computer-program product in another computer memory. For example, the set of instructions can be stored as a computer-program product in a disk drive attached to a microcomputer or in a plurality of disk drives attached to microcomputers throughout a distributed computer network. The computer-program product can also be stored at another computer and transmitted, when desired, to a user's workstation by an internal or external network. Those skilled in the art can appreciate the physical storage of the sets of instructions physically changes the medium upon which it is stored so that the medium carries computer-readable information. The change can be electrical, magnetic, chemical or some other physical change. While it is convenient to describe the invention in terms of instructions, symbols, characters, or the like, the reader should remember that all of these and similar terms should be associated with the appropriate physical elements.

It is also important to note that as indicated herein, the term “module” can refer to a collection of routines, subroutines and data structures thereof that perform tasks or which can implement an abstract data type. Thus, a “module” can be configured as a software module. Such a module can comprise at least two portions or functions. First, a module can include an interface, which lists the variables, constants, data types, routines and subroutines that can be accessible by other modules, routines, or subroutines. Second, a module can include an implementation, which is generally private (i.e., accessed only by that module) and which includes a source code that actually can implement the routines, subroutines, and or data types within the module. The term “module” is well known in the art and thus can refer to a software module and/or a self-contained module of data.

Note also that the terms “Internet” and “Intranet” are well known in the art and thus a detailed description of how the Internet functions or an Intranet operates is not necessary. Generally, however, the “Internet” is known as the worldwide collection of networks and gateways that utilize the TCP/IP suite of protocols to communicate with one another. An “Intranet” is essentially a distributed computer network designed for information and data processing within a particular company or organization, and also typically employs technologies and applications associated with the Internet, such as, for example, Web pages, Web browsers, Web servers, FTP sites, e-mail, newsgroups, mailing lists and so forth. Most Intranet-based computer networks are generally accessible only to those within the company or organization.

Those skilled in the art can appreciate that although the present invention has been discussed in terms of business-to-business or trading network applications and systems thereof, the present invention can also be implemented in the context of other implementations. For example, the present invention can be implemented to assist in the performance of complex calculations, such as complex end user applications in the energy, bioinformatics and complex entertainment arts.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is thus not intended to be exhaustive or to limit the scope of the invention. Many modifications and variations are possible in light of the above teaching without departing from scope of the following claims. It is contemplated that the use of the present invention can involve components having different characteristics. It is intended that the scope of the present invention be defined by the claims appended hereto, giving full cognizance to equivalents in all respects.

1. A method for dynamic data-centered programming in a distributed computer network, said method comprising the steps of:
dynamically associating a software method with an instance of incoming data utilizing at least one processing node within said distributed computer network;
dynamically locating said software method utilizing a discovery mechanism integrated with said distributed computer network; and
dynamically fetching said software method from any location with said distributed computer network, wherein said at least one processing node dynamically programs itself for a current instance of incoming data, such that all future instances of an identical type of incoming data are processed utilizing said software method without searching said distributed computer network and downloading said software method.

2. The method of claim 1 further comprising the step of:
dynamically determining said software method prior to dynamically associating said software method with said instance of incoming data utilizing said at least one processing node.

3. The method of claim 1 wherein the step of dynamically associating an software method with an instance of incoming data utilizing at least one processing node within said distributed computer network, further comprises the step of:
dynamically associating a software method with said instance of a portion of incoming data utilizing said at least one processing node within said distributed computer network.

4. The method of claim 1 wherein said discovery mechanism comprises a flexible, ordered, network-wide discovery technique integrated within said distributed computer network.

5. The method of claim 1 further comprising the step of:
dynamically discovering said software method utilizing said discovery mechanism integrated with said distributed computer network.

6. The method of claim 1 further comprising the step of:
permitting said at least one processing node to dynamically download at least one software method corresponding to data received from an external data source.

7. The method of claim 1 further comprising the step of:
permitting said at least one processing node to receive data in association with at least one software method intended to process said data from an upstream device.

8. The method of claim 7 wherein said upstream device comprises at least one other processing node present within said distributed computer network.

9. The method of claim 7 wherein said upstream devices comprises a source device.

10. The method of claim 1 further comprising the steps of:
permitting said at least one processing node to request and receive at least one software method from at least one other processing node within said distributed computer network.

11. The method of claim 1 wherein said software method is obtainable by said at least one processing node from a collection of software methods available to said at least one processing node.

12. The method of claim 11 further comprising the step of:
designating a name, which permits a selection of a software method from said collection of software methods available to said at least one processing node.

13. The method of claim 12 further comprising the step of:
deriving a name of a software method available from said collection software methods from a predetermined position of incoming data.

14. The method of claim 12 further comprising the step of:
deriving a name of a software method available from said collection software methods from a value of a predetermined element of incoming data.

15. The method of claim 12 further comprising the step of:
deriving a name of a software method available from said collection software methods by utilizing a value of a predetermined element of incoming data as a pointer to a location containing said name.

16. The method of claim 15 further comprising the step of:
deriving a name of a software method available from said collection software methods by utilizing a value of a predetermined element of incoming data as a pointer to a location containing said name and content of a required software method.

17. The method of claim 12 further comprising the step of deriving a name of a software method available from said collection software methods by concatenating at least one of the following:
an identity of said at least one processing node;
a role of said at least one processing node;
a value of at least one element of incoming data;
a name of at least one element of incoming data;
a function that must be performed by said software method.

18. The method of claim 1 further comprising the step of:
locating said software method in a location within said distributed computer network.

19. The method of claim 18 further comprising the step of:
locating said software method in a predetermined position of incoming data.

20. The method of claim 19 further comprising the step of:
locating said software method as a value of a predetermined element of incoming data.

21. The method of claim 19 further comprising the step of:
locating said software method within a memory of said at least one processing node.

22. The method of claim 19 further comprising the step of:
locating said software method within an attached storage device dedicated to said at least one processing node.

23. The method of claim 19 further comprising the step of:
locating said software method within a remote storage device dedicated to said at least one processing node.

24. The method of claim 19 further comprising the step of:
locating said software method within an attached storage device shared by said at least one processing node and at least one other device.

25. The method of claim 19 further comprising the step of:
locating said software method within a remote storage device shared by said at least one processing node and at least one other device.

26. The method of claim 19 further comprising the step of:
locating said software method within at least one other processing node within said distributed computer network.

27. The method of claim 19 further comprising the step of:
specifying a location of said software method in a predetermined position of incoming data.

28. The method of claim 19 further comprising the step of:
specifying a location of said software method as a value of a predetermined element of incoming data.

29. The method of claim 19 further comprising the step of:
specifying a location of said software method as a value of a predetermined element of incoming data, such that said value is adapted for use as a key to a plurality of names corresponding to said location of said software method.

30. The method of claim 19 further comprising the step of:
specifying a location of said software method as a value of a predetermined element of incoming data, wherein said value is adapted for use as a pointer to a location containing said location of said software method.

31. The method of claim 1 further comprising the step of:
establishing a search order by which a software method is searched.

32. The method of claim 31 further comprising the step of:
programming said search order into said processing node.

33. The method of claim 31 further comprising the step of:
embedding said search order within said incoming data in a predetermined position of said incoming data.

34. The method of claim 33 further comprising the step of:
embedding said search order within incoming data as a value of a predetermined element within said incoming data, thereby permitting at least one processing node to send said search order to another processing node within said distributed computer network.

35. The method of claim 31 further comprising the step of:
permitting said search order to be made available in an external storage medium, such that a location and a path to said search order are specified in a predetermined position of said incoming data.

36. The method of claim 35 further comprising the step of:
permitting said search order to be made available in an external storage medium, such that a location and a path to said search order are specified in a predetermined element of said incoming data.

37. A system for dynamic data-centered programming in a distributed computer network, said system comprising:
module for dynamically associating a software method with an instance of incoming data utilizing at least one processing node within said distributed computer network;
module for dynamically locating said software method utilizing a discovery mechanism integrated with said distributed computer network; and
module for dynamically fetching said software method from any location with said distributed computer network, wherein said at least one processing node dynamically programs itself for a current instance of incoming data, such that all future instances of an identical type of incoming data are also processed utilizing said software method without searching said distributed computer network and downloading said software method.

38. The system of claim 37 further comprising:
module for dynamically determining said software method prior to dynamically associating said software method with said instance of incoming data utilizing said at least one processing node.

39. The system of claim 37 further comprising:
module for dynamically associating a software method with an instance of a portion of incoming data utilizing said at least one processing node within said distributed computer network.

40. The system of claim 37 wherein said discovery mechanism comprises a flexible, ordered, network-wide discovery technique integrated within said distributed computer network.

41. The system of claim 37 further comprising:
module for dynamically discovering said software method utilizing said discovery mechanism integrated with said distributed computer network.

42. The system of claim 37 wherein said at least one processing node is permitted to dynamically download at least one software method corresponding to data received from an external data source.

43. The system of claim 37 wherein said at least one processing node is permitted to receive data in association with at least one software method intended to process said data from an upstream device.

44. The system of claim 43 wherein said upstream device comprises at least one other processing node present within said distributed computer network.

45. The system of claim 43 wherein said upstream devices comprises a source device.

46. The system of claim 37 wherein said at least one processing node is permitted to request and receive at least one software method from at least one other processing node within said distributed computer network.

47. The system of claim 37 wherein said software method is obtainable by said at least one processing node from a collection of software methods available to said at least one processing node.

48. The system of claim 47 wherein a name can be designated, which permits a selection of a software method from said collection of software methods available to said at least one processing node.

49. The system of claim 48 wherein a name of a software method available from said collection software methods is derivable from a predetermined position of incoming data.

50. The system of claim 48 wherein a name of a software method available from said collection software methods is derivable from a value of a predetermined element of incoming data.

51. The system of claim 48 wherein a name of a software method available from said collection software methods is derivable by utilizing a value of a predetermined element of incoming data as a pointer to a location containing said name.

52. The system of claim 51 wherein a name of a software method available from said collection software methods is derivable by utilizing a value of a predetermined element of incoming data as a pointer to a location containing said name and content of a required software method.

53. The system of claim 48 wherein a name of a software method available from said collection software methods is derivable by concatenating at least one of the following:
an identity of said at least one processing node;
a role of said at least one processing node;
a value of at least one element of incoming data;
a name of at least one element of incoming data; and
a function that must be performed by said software method.

54. The system of claim 37 wherein said software method is located in a location within said distributed computer network.

55. The system of claim 54 wherein said software method is located in a predetermined position of incoming data.

56. The system of claim 55 wherein said software method is located as a value of a predetermined element of incoming data.

57. The system of claim 55 wherein said software method is located within a memory of said at least one processing node.

58. The system of claim 55 wherein said software method is located within an attached storage device dedicated to said at least one processing node.

59. The system of claim 55 wherein said software method is located within a remote storage device dedicated to said at least one processing node.

60. The system of claim 55 wherein said software method is located within an attached storage device shared by said at least one processing node and at least one other device.

61. The system of claim 55 wherein said software method is located within a remote storage device shared by said at least one processing node and at least one other device.

62. The system of claim 55 wherein said software method is located within at least one other processing node.

63. The system of claim 55 wherein a location of said software method is specified in a predetermined position of incoming data.

64. The system of claim 55 wherein a location of said software method is specified as a value of a predetermined element of incoming data.

65. The system of claim 55 wherein a location of said software method is specified as a value of a predetermined element of incoming data, such that said value is adapted for use as a key to a plurality of names corresponding to said location of said software method.

66. The system of claim 55 wherein a location of said software method is specified as a value of a predetermined element of incoming data, wherein said value is adapted for use as a pointer to a location containing said location of said software method.

67. The system of claim 37 further comprising a search order by which said software method may be searched.

68. The system of claim 67 wherein said search order is programmable into said processing node.

69. The system of claim 67 wherein said search order is embedded within said incoming data in a predetermined position of said incoming data.

70. The system of claim 69 wherein said search order is embedded within said incoming data as a value of a predetermined element within said incoming data, thereby permitting at least one processing node to send said search order to another processing node within said distributed computer network.

71. The system of claim 67 wherein said search order is made available in an external storage medium, such that a location and a path to said search order are specified in a predetermined position of said incoming data.

72. The system of claim 1 wherein said search order is made available in an external storage medium, such that a location and a path to said search order are specified in a predetermined element of said incoming data.

73. A system for dynamic data-centered programming in a distributed computer network, said system comprising:
module for dynamically associating a software method with an instance of incoming data utilizing at least one processing node within said distributed computer network;
module for dynamically locating said software method utilizing a discovery mechanism integrated with said distributed computer network;
module for dynamically fetching said software method from any location with said distributed computer network, wherein said at least one processing node can dynamically program itself for a current instance of incoming data, such that all future instances of an identical type of incoming data are also processed utilizing said software method without searching said distributed computer network and downloading said software method;
module for dynamically determining said software method prior to dynamically associating said software method with said instance of incoming data utilizing said at least one processing node;
module for dynamically associating a software method with an instance of a portion of incoming data utilizing said at least one processing node within said distributed computer network; and
wherein said discovery mechanism comprises a flexible, ordered, networkwide discovery technique integrated within said distributed computer network.
